(19) United States
(12) Patent Application Publication
(10) Pub. No.: US 2018/0061256 A1
(43) Pub. Date: Mar. 1, 2018

(54) AUTOMATED DIGITAL MEDIA CONTENT EXTRACTION FOR DIGITAL LESSON GENERATION

(71) Applicant: WeSpeke, Inc., Pittsburgh, PA (US)

(72) Inventors: Michael E. Elchik, Moon Township, PA (US); Dafyd Jones, Edgeworth, PA (US); Robert J. Pawlowski, JR., Cranberry Township, PA (US); Jaime G. Carbonell, Pittsburgh, PA (US); Jeremy Hesidenz, McKees Rocks, PA (US); Sean Hile, Gibsonia, PA (US); Cathy Wilson, Glenview, IL (US)

(21) Appl. No.: 15/803,224

(22) Filed: Nov. 3, 2017

Related U.S. Application Data
(63) Continuation-in-part of application No. 15/586,906, filed on May 4, 2017, now Pat. No. 9,812,028.
Application No. 15/586,906 is a continuation-in-part of application No. 15/415,314, filed on Jan. 25, 2017.
(60) Provisional application No. 62/331,490, filed on May 4, 2016.
(60) Provisional application No. 62/428,260, filed on Nov. 30, 2016.
(60) Provisional application No. 62/286,661, filed on Jan. 25, 2016.
(60) Provisional application No. 62/331,490, filed on May 4, 2016.
(60) Provisional application No. 62/428,260, filed on Nov. 30, 2016.

(51) Int. Cl. G09B 5/02; G06F 17/27; G10L 15/26; G06F 3/16

(52) U.S. Cl. CPC G09B 5/02; G06F 17/2765; G10L 15/265; G06F 3/167; G06F 17/274; G06F 17/2785; G06F 17/2705

(57) ABSTRACT

An automated lesson generation learning system extracts text-based content from a digital media file. The system parses the extracted content to identify key words to use with prompts in the lesson. The system also may automatically generate a clip from the digital media file, so that the clip is the portion of the file in which the sentence is spoken. The system then automatically generates and outputs a lesson containing the prompt, and optionally the clip. The system may process a user's spoken response to the prompt to determine whether the user correctly pronounced the response.

### CROSS REFERENCE TO RELATED APPLICATIONS

This patent document is a continuation-in-part of U.S. patent application Ser. No. 15/586,906, filed May 4, 2017, which claims priority to: (1) U.S. Provisional Patent Application No. 62/331,490, filed May 4, 2016; and (2) U.S. Provisional Patent Application No. 62/428,260, filed Nov. 30, 2016. The disclosure of each priority application is incorporated into this document by reference.

This patent document is also a continuation-in-part of U.S. patent application Ser. No. 15/415,314, filed Jan. 25, 2017, which claims priority to: (1) U.S. Provisional Patent Application No. 62/286,661, filed Jan. 25, 2016; (2) U.S. Provisional Patent Application No. 62/331,490, filed May 4, 2016; and (3) U.S. Provisional Patent Application No. 62/428,260, filed Nov. 30, 2016. The disclosure of each priority application is incorporated into this document by reference.

### BACKGROUND

Cost effective, high quality, culturally sensitive and efficient systems for automatically creating skills development content that engages students have evaded the global market for skills development systems. Currently, language acquisition and language proficiency is accomplished through numerous, disparate methods including but not limited to classroom teaching, individual tutors, reading, writing, and content immersion. However, most content designed for language learning (such as a textbook) is not engaging or of particular interest to a language learner. Other forms of learning, such as hiring individual tutors, can be prohibitively expensive.

Limitations in current technology do not permit the automatic development of language learning content that is both contextually-relevant and engaging to students.

In addition, in recent years several applications and services have become available to help individuals learn foreign languages at their own pace, on electronic devices. Some of these applications and services are even used in classrooms to augment in-person language learning. While automated systems can help many students learn new languages, automated systems often fail to provide students with constructive feedback on their progress. In particular, a student may know how to read a foreign word or phrase, and may even recognize the word when spoken, but may fail to correctly pronounce the word in conversation.

This document describes methods and systems that are directed to solving at least some of the issues described above.

### SUMMARY

In an embodiment, a system for automatically processing digital media files and generating digital lessons content based on content of the digital media files includes a content analysis engine and a lesson generation engine, each of which comprises programming instructions stored on a memory device, and each of which are configured to cause a processor to perform certain functions. The system will analyze a set of text corresponding to words spoken in a digital media file, extract a text segment from the set of text, determine a start time for the text segment, and generate a digital media clip that corresponds to the text segment. The digital media clip will have a start time in the digital media file that corresponds to the start time of the text segment. The system will generate a lesson comprising an exercise that includes the digital media clip, along with a prompt that uses one or more key words that are extracted from the text segment.

In various embodiments, examples of exercises may include one or more of the following: (i) a fill-in-the-blank exercise, in which the prompt is a blank in the text segment wherein a user may insert one of the key words in the blank; (ii) a sentence scramble exercise, in which the prompt is a field in which a user may arrange key words from the text segment in order; (iii) a word scramble exercise, in which the prompt is a field in which a user may arrange a set of letters into one of the key words; or (iv) a definition exercise, in which the prompt is a field in which a user may select a definition for one of the key words.

Optionally, the system also may include programming instructions that are configured to cause a media presentation device to, when outputting the lesson: (i) display the prompt in a prompt-and-response sector of a display of the media presentation device wherein a user may enter a response to the prompt; and (ii) display the digital media clip in a video presentation sector of the display with an actuator via which the user may cause the media presentation device to play the digital media clip and output audio comprising the sentence.

Optionally, the system also may include programming instructions that are configured to cause a media presentation device to, when outputting the lesson: (i) output the prompt; (ii) receive a spoken response to the prompt via an audio input device of the media presentation device. The system may analyze the spoken response to determine whether the spoken response matches the key word. If the spoken response matches the key word, the system may output a positive reinforcement. If the spoken response does not match the key word, the system may output the key word via an audio speaker and continue to output the prompt and receive additional spoken responses until an additional spoken response matches the key word.

Optionally, the system may identify a topic for the lesson and access a set of user profiles that include interests for associated users. In some embodiments, the system may identify a user having at least a threshold level of interests that match or are complementary to the topic of the lesson, and cause the lesson to be presented to the identified user. In other embodiments, the system may receive a user request for a lesson, access a data set of lessons that includes the generated lesson, identify a lesson having a topic that matches or is complementary to at least a threshold level of interests in the user profile, and cause a media presentation to present the identified lesson to the user.

In another embodiment, a system for processing digital media files and automatically generating digital lesson content based on content of the digital media files includes a lesson generation engine that includes a computer-readable medium with programming instructions that are configured to cause a processing device to analyze a set of text in a digital media file. The system will identify a text segment in the text, identify a key word in the text segment, and generate a lesson that includes a prompt in which the key word is replaced with a blank. The system also will include a computer-readable medium with programming instructions that are configured to cause a media presentation device to output the prompt to a user, receive a spoken response to the prompt via a microphone, and analyze the spoken response to determine whether the spoken response matches the key word. If the spoken response does not match the key word, the system may output the key word via an audio speaker and continue to output the prompt and receive additional spoken responses until an additional spoken response matches the key word.

Optionally, the instructions to analyze the spoken response to determine whether the spoken response matches the key word may include instructions to compare the spoken response to audio characteristics of the key word and one or more variations of the key words. Optionally, the one or more variations of the key word comprise one or more alternate tenses of the key word or one or more alternate singular/plural forms of the key word. Optionally, the instructions to analyze the spoken response to determine whether the spoken response matches the key word may include instructions to transmit the spoken response to a speech-to-text recognition service. Optionally, the instructions to output the prompt to the user may include instructions to display text of the prompt with the blank instead of the key word, and also to output the prompt in a spoken audio form that includes the key word.

Optionally, the system may identify a topic for the lesson and access a set of user profiles that include interests for associated users. In some embodiments, the system may identify a user having at least a threshold level of interests that match or are complementary to the topic of the lesson, and when the media presentation device outputs the lesson it may cause the lesson to be presented to the identified user. In other embodiments, the system may receive a request from the user of the media presentation device for a lesson, access a data set of lessons that includes the generated lesson, identify a lesson having a topic that matches or is complementary to at least a threshold level of interests in the user profile, and cause a media presentation to present the identified lesson to the user.

In other embodiments, a system for automatically generating and presenting lessons based on content of a digital media file includes a processor, a data set of user profiles; and a non-transitory computer readable storage medium containing programming instructions. The instructions are configured to cause the processor to analyze a set of text corresponding to words in a digital media file, and to extract a text segment from the set of text. The instructions also are configured to cause the processor to identify a topic for the digital media file, generate a lesson that includes at least a portion of the text segment in a prompt that has an expected response, associate the topic with the lesson, access a plurality of user profiles that include one or more interests for a user that is associated with the user profile, identify a user having at least a threshold level of interests that match or are complementary to the topic, and cause the lesson to be delivered to the identified user. The media presentation device is a media presentation device of the identified user. The system will extract one or more key words from the text segment that appear in the text segment at a frequency that exceeds a threshold. The system will generate a lesson comprising an exercise that includes a prompt that uses the one or more key words extracted from the text segment, along with the digital media clip.

### BRIEF DESCRIPTION OF THE DRAWINGS

FIG. 1 illustrates a system that may be used to generate lessons based on content from digital media.

FIG. 2 is a process flow diagram of various elements of an embodiment of a lesson presentation system.

FIGS. 3 and 4 illustrate examples of how lessons created from digital videos may be presented.

FIG. 5 illustrates additional process flow examples.

FIG. 6 illustrates additional details of an automated lesson generation process.

FIG. 7 illustrates an example word-definition matching exercise.

FIG. 8 shows various examples of hardware that may be used in various embodiments.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” and each derivative of that term means “including, but not limited to.”

As used in this document, the terms “digital media service” and “digital media delivery service” refer to a system, including transmission hardware and one or more non-transitory data storage media, that is configured to transmit digital content to one or more users of the service over a communications network such as the Internet, a wireless data network such as a cellular network or a broadband wireless network, a digital television broadcast channel or a cable television service. Digital content may include static content (such as web pages or electronic documents), dynamic content (such as web pages or document templates with a hyperlink to content hosted on a remote server), digital audio files or digital video files. For example, a digital media service may be a news and/or sports programming service that delivers live and/or recently recorded content relating to current events in video format, audio format and/or text format, optionally with images and/or closed-captions.

As used in this document, the terms “digital media file” and “digital media asset” each refers to a digital file containing one or more units of digital audio and/or visual content that an audience member may receive from a digital media service and consume (listen to and/or view) on a media presentation device. Digital media files may include one or more tracks that are a video along with one or more tracks that are associated with the video, such as an audio channel. Digital video files also may include one or more text channels, such as closed captioning. A digital media file may be transmitted as a downloadable file or in a streaming format. Thus, a digital media asset may include streaming media and media viewed via one or more client device applications, such as a web browser. Examples of digital media assets include, for example, videos, podcasts, news reports to be embedded in an Internet web page, and the like.

As used in this document, a “lesson” is a digital media asset, stored in a digital media file or database or other electronic format that contains content that is for use in skills development. For example, a lesson may include language learning content that is directed to teaching or training a user in a language that is not the user's native language. A lesson will include instructions that cause an electronic device to output the learning content with various prompts, at least some of which will require a response from a user of the electronic device before the next prompt is presented.

A “media presentation device” refers to an electronic device that includes a processor, a computer-readable memory device, and an output interface for presenting the audio, video, data and/or text components of content from a digital media file and/or from a lesson. Examples of output interfaces include, for example, digital display devices and audio speakers. The device's memory may contain programming instructions in the form of a software application that, when executed by the processor, causes the device to perform one or more operations according to the programming instructions. Examples of media presentation devices include personal computers, laptops, tablets, smartphones, media players, voice-activated digital home assistants and other Internet of Things devices, wearable virtual reality headsets and the like.

This document describes an innovative system and technological processes for developing material for use in content-based learning, such as language learning. Content-based learning is organized around the content that a learner consumes. By repurposing content, for example content of a digital video, to drive learning, the system may lead to improved efficacy in acquisition and improved proficiency in performance in the skills to which the system is targeted.

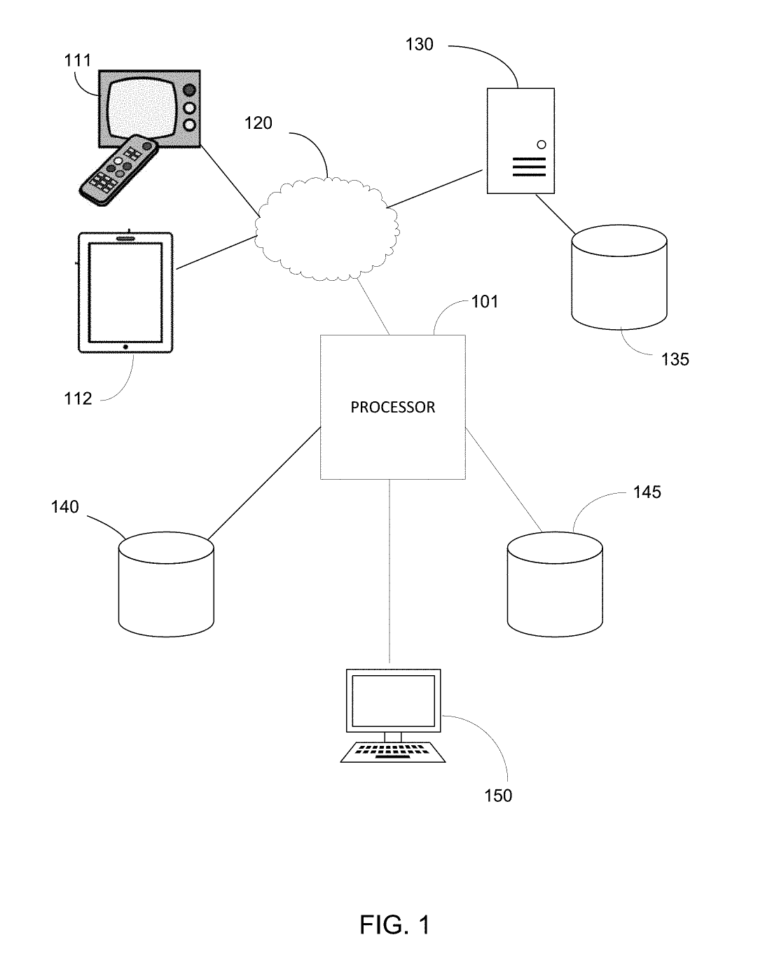

FIG. 1 illustrates a system that may be used to generate lessons that are contextually relevant to content from one or more digital video files. The system may include a central processing device 101, which is a set of one or more processing devices and one or more software programming modules that the processing device(s) execute to perform the functions of a content analysis engine and/or a lesson generation engine, as described below

Multiple media presentation devices such as smart televisions 111 and/or computing devices 112 may be in direct or indirect communication with the processing device 101 via one or more communication networks 120. The media presentation devices receive lessons and output the lessons to users. The media presentation devices also may output digital media files in downloaded or streaming format and present the content associated with those digital media files to users as text, graphics and/or video. Optionally, to view videos, each media presentation device may include a video presentation engine comprising a processor and programming instructions configured to cause a display device of the media presentation device to output a video served by the video delivery service, and/or it may include an audio content presentation engine comprising a processor and programming instructions configured to cause a speaker of the media presentation device to output an audio stream served by the video delivery service. The media presentation device also may include a microphone to detect words spoken by the user, along with associated programming and circuitry to analyze the spoken words and convert the words to a digital format.

Any number of digital media services may contain one or more digital media servers 130 that include processors, communication hardware and a library of lessons and other digital media files that the servers send to the media presentation devices via the network 120. The digital media files may be stored in one or more data storage facilities 135. A digital media server 130 may transmit the digital media files in a streaming format, so that the media presentation devices present the content from the digital media files as the files are streamed by the digital media server 130. Alternatively, the digital media server 130 may make the digital media files available for download to the media presentation devices. In addition, the digital media server 130 may make the digital media files available to the processor 101 of the content analysis engine.

The lessons may be stored in the digital media server and delivered to end user devices for use in language learning. Alternatively or in addition, the digital media server 130 may make digital media files available to a content analysis engine for development of lessons. To implement the content analysis engine, the system also may include a data storage facility 140 containing content analysis programming instructions that are configured to cause a processor 101 to serve as the content analysis engine. The content analysis engine will extract segments of text corresponding to words spoken in the video or in an audio component of a digital video or audio file, or text appearing in a digital document such as a transcript, article or page. If the text is extracted from a digital video or audio file, the system may record the text in a transcript or other format. The file may include a timestamp for some or all of the segments. The timestamp is data that can be used to measure the start time and duration of the segment. The content analysis engine may be a component of the digital media server 130 or a system associated with the digital media server 130, or it may be an independent service that may or may not be associated with the digital media server (such as one of the media presentation devices or the processor 101 as shown in FIG. 1).

In some embodiments, the content analysis engine may identify a language of the extracted text, a named entity in the extracted text, and one or more parts of speech in the extracted text.

In some embodiments, the segments extracted by the content analysis engine will include one or more discrete sentences (each, a single sentence). In some embodiments, segments of extracted text may include phrases, clauses and other sub-sentential units as well as super-sentential units such as dialog turns, paragraphs, etc.

The system also may include a data storage facility 145 containing lesson generation programming instructions that are configured to cause the processor to serve as a lesson generation engine. The lesson generation engine will automatically generate a set of questions for a lesson associated with the language.

In various embodiments a lesson may include a set of prompts. For one or more of the prompts, a named entity that was extracted from the content may be part of the prompt or a response to the prompt. Similarly, one or more words that correspond to an extracted part of speech may be included in a prompt or in the response to the prompt. In other embodiments the set of prompts may include a prompt in which content of the single sentence is part of the prompt or the expected answer to the prompt.

In some embodiments, prior to performing text extraction, the content analysis engine may first determine whether the digital media file satisfies one or more screening criteria for objectionable content. The system may require that the digital media file satisfy the screening criteria before it will extract text and/or use the digital media file in the generation of a lesson.

Example procedures for determining whether a digital media file satisfies screening criteria will be described below.

Optionally, the system may include an administrator computing device 150 that includes a user interface that allows an administrator to view and edit any component of a lesson before the lesson is presented to a user. Ultimately, the system will cause a user interface of a user's media presentation device (such as a user interface of the computing device 112) to output the lesson to a user. One possible format is a format by which the user interface outputs the prompts one at a time, a user may enter a response to each prompt, and the user interface outputs a next prompt after receiving each response.

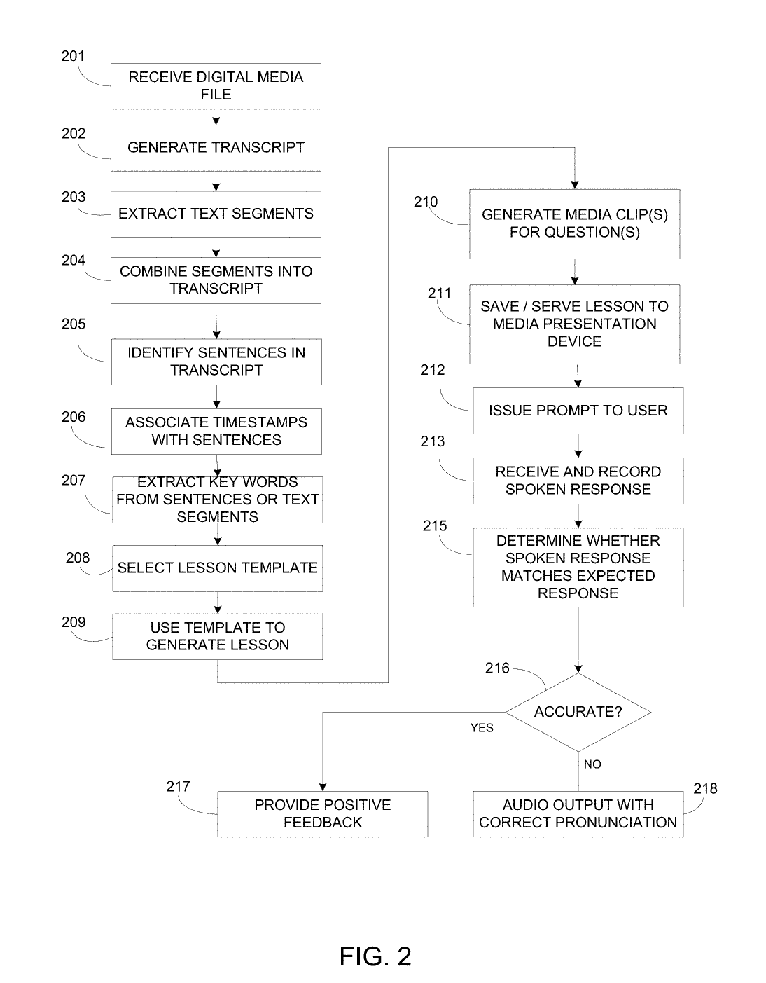

FIG. 2 is a process flow diagram of various elements of an embodiment of a learning system that automatically generates and/or presents a learning lesson with prompts that may be relevant to a digital media asset. In some embodiments, the prompts may be retrieved from storage in one or more digital files. In other embodiments, prompts may be generated using procedures such as those described below. For example, when a digital media server serves (or before the digital media server serves) a digital media file to the content analysis engine, the content analysis engine will receive the digital media file 201 and extract segments of text 203 from the digital media file to identify suitable information to use in a lesson. In such a situation, extraction may occur from a transcript or text-based media file, as well as from an audio or video file.

If the text is a transcript of an audio track, the system may identify and extract the text segments 203 by parsing the transcript of the text to find timestamps that identify a starting point for each segment. For example, a transcript may include start time and duration values for each segment and the system may use these values to identify sentences in the transcript. By way of example, a transcript of a digital video may include the following sentences:

“Famed abolitionist Harriet Tubman was born into slavery in Maryland, but eventually escaped with help from the Underground Railroad. After her own brave escape, Tubman went on to lead more than 300 slaves north out of Maryland to freedom.”

The transcript may break these two sentences into four consecutive text segments:

SEGMENT 1: <p t=“45270” d=“4839”>Famed abolitionist Harriet Tubman was born into slavery in Maryland, but eventually escaped</p>

SEGMENT 2: <p t=“50109” d=3183”>with help from the Underground Railroad. After her own brave escape, </p>

SEGMENT 3: <p t=“53292” d=“3246”>Tubman went on to lead more than 300 slaves north out of Maryland</p>

SEGMENT 4: <p t=“56538” d=“1010”>to freedom.</p>

In each of the four text segments listed above, the segment starts with a timestamp in which t=start time and d=duration (in milliseconds) of the segment. (Other values of measurement may be used in other embodiments.) If multiple transcripts are available for various portions of the video, optionally the content analysis engine may combine the transcript segments into a single transcript 204.

If a transcript is not available, the system may automatically generate a transcript 202 by analyzing the audio and converting it to a text transcript using any suitable speech-to-text conversion technology.

Once the transcript is available and/or created, the system may parse the transcript into sentences 205. The system may do this using any suitable sentence parser, such as by using a lexicalized parser (an example of which is available from the Stanford Natural Language Processing Group.) This system may look for sequential strings of text and look for a start indicator (such as a capitalized word that follows a period, which may signal the start of a sentence or paragraph) and an end indicator (such as ending punctuation, such as a period, exclamation point or question mark to end a sentence, and which may signal the end of a paragraph if followed by a carriage return). In a digital audio file or digital video file, the system may analyze an audio track of the video file in order to identify pauses in the audio track having a length that at least equals a length threshold. A “pause” may in some embodiments be a segment of the audio track having a decibel level that is at or below a designated threshold decibel level. The system will select one of the pauses and an immediately subsequent pause in the audio track. In other embodiments, the segmentation may happen via non-speech regions (e.g. music or background noise) or other such means. The system will process the content of the audio track that is present between the selected pause and the immediately subsequent pause to identify text associated with the content, and it will select the identified text as the single sentence. Alternatively, the content analysis engine may extract discrete sentences from an encoded data component. If so, the content analysis engine may parse the text and identify discrete sentences based on sentence formatting conventions such as those described above. For example, a group of words that is between two periods may be considered to be a sentence.

The system may also associate timestamps with one or more sentences 206 by placing timestamps in the transcript at locations that correspond to starting points and/or ending points of sentences. The timestamps in the transcript will correspond to times at which the text immediately following (or preceding) the timestamp appears in the actual audio track. Optionally, a timestamp also may include a duration value. The system may do this by retrieving all segments and partial segments that make up the sentence, and using the timestamps of those segments to generate the sentence timestamp. For example, the system may use the timestamp of the first segment that chronologically appears in the sentence as the timestamp for the sentence, and it may use a duration that is equal to the sum of all of the durations in the sentence. In the four-segment example listed above, the system may recognize that the four segments form a two-sentence sequence, it may associate t=45270 as the starting time of the two-sentence sentence, and it may associate a d=12278 (i.e., the sum of the four durations) as the duration of the two-sentence segment.

If sequential segments form a single sentence, then in step 206 the system may associate the timestamp with that single sentence. If sequential segments form a sequence of two or more sentences, then in step 206 the system may associate the timestamp with the sentence sequence. Alternatively, the system may combine a group of sequential segments that form a multiple-sentence set, parse the group into sentences in step 205, and associate timestamps with each individual sentence in step 206. The system may use the timestamps of each text segment that is at least partially included within a sentence to associate a timestamp with that sentence. To associate the timestamp with individual sentences in a multi-sentence sequence, the content analysis engine may determine a start time for each sentence. The system may do this by: (i) identifying a first segment in the sentence; (ii) determining a number of syllables in that segment; (iii) determining a ratio of the number of syllables that are in the sentence fragment to the number of syllables in the entire segment; and (iv) multiplying the syllable ratio by the total duration of the segment. The system will repeat this for each segment that is at least partially included in the sentence and determine a duration for each sentence as a sum of the segment durations.

By way of example, using the second sentence of the four-segment example presented above, the system may identify that the sentence starts within Segment 2 and terminates at the end of Segment 4. If the sentence started at the beginning of the segment, the start time would simply be 50109. But since it starts in the middle of the segment, the system will compute the start time by determining the syllable ratio of the segment's sentence fragment to that of the entire segment. (In this case, the ratio is 9 syllables in the sentence fragment/16 syllables in the entire segment.) The system will then multiply the syllable ratio (9/16) by the total duration of the segment (3183 ms) to obtain the duration (1790) The system will add the resulting duration to the start time of the segment 50109 to identify the sentence start time. Thus, in this example, the computed start time for the second sentence is: 9/16*3183+50109=51899 ms. The system will then determine the duration of the second sentence as a sum of the duration of Segment 2 in the sentence (7/16*3183=1393) plus the durations of all other segments in the sentence (in this case, Segments 3 and 4). Thus, the total duration is 7/16*3183+3246+1010=5649 ms.

In case a particular digital media player is not capable of processing a timestamp having values equal to the timestamp's values, the system may modify the timestamps to provide alternate values that are processable by the media player. For example, the system may round each start time and duration to the nearest second (from milliseconds) to account for video players that are unable to process millisecond timestamps. Other methods are possible.

The system may analyze the parsed sentences or extracted text segments to identify key words or other information to be used in the lesson. The key words may include, for example, words or phrases that define one or more topics, words or phrases that represent one or more named entities identified by named entity recognition (which will be described in more detail below), and/or words or phrases that represent an event from the analyzed content. The system may extract the key words 207 from the content using any suitable content analysis method. For example, the system may process a transcript as described above and extract key words from the transcript. Alternatively, the system may process an audio track of the video with a speech-to-text conversion engine to yield text output, and then parse the text output to identify the language of the text output, the topic, the named entity, and/or one or more parts of speech. Optionally, the system may compare the text segment to a database known by key words to identify whether any of the known key words are present in the sentence. Alternatively, the system may process the text segment and select as a key word named entity, a noun that is the subject, a verb, or other selection criteria. Alternatively, the system may process a data component that contains closed captions by decoding the encoded data component, extracting the closed captions, and parsing the closed captions to identify the language of the text output, the topic, the named entity, and/or the one or more parts of speech. Suitable engines for assisting with these tasks include the Stanford Parser, the Stanford CoreNLP Natural Language Processing ToolKit (which can perform named entity recognition or “NER”), and the Stanford Log-Linear Part-of-Speech Tagger, the Dictionaries API (available for instance from Pearson). Alternatively, the NER can be programmed directly via various methods known in the field, such as finite-state transducers, conditional random fields or deep neural networks in a long short term memory (LSTM) configuration. One novel contribution to NER extraction is that the audio or video corresponding to the text may provide additional features, such as voice inflections, human faces, maps, etc. time-aligned with the candidate text for the NER. These time-aligned features are used in a secondary recognizer based on spatial and temporal information implemented as hidden Markov model, a conditional random field, a deep neural network or other methods. A meta-combiner, which votes based on the strength of the sub-recognizers (from text, video and audio), may produce the final NER output recognition. To provide additional detail, a conditional random field takes the form of:

$$p ( y \vert \vec{x} ) = \frac{1}{Z ( \vec{x} )} exp ( θ + {\sum }_{j = 1}^{K} {θ}_{y , j} ( \vec{x} ) )$$

yielding the probability that there is a particular NER y given the input features in the vector x. And a meta-combiner does weighted voting from individual extractors as follows:

$$P ( y \vert {\vec{x}}_{1} , … {\vec{x}}_{n} ) = {w}_{j} {max}_{{y}_{i}} ( p ( {y}_{i} \vert {\vec{x}}_{i} ) ) ,$$

where w is the weight (confidence) of each extractor. The system may identify key words based on the frequency within which they appear in the content, such as key words that appear (with semantically similar terms) most frequently in the text, or in at least another threshold level of frequency.

The system may then select a language learning lesson template 208 with which to use the key words, and it automatically generates a lesson 209 according to the template. For example, the system may generate prompts with questions or other exercises in which the exercise is relevant to a topic, and/or in which the key word is part of the question, answer or other component of the exercise or in which the key word is replaced with a blank that the student must fill in. The system may obtain a template for the exercise from a data storage facility containing candidate exercises such as (1) questions and associated answers, (2) missing word exercises, (3) sentence scramble exercises, and (4) multiple choice questions. The content of each exercise may include blanks in which named entities, parts of speech, or words relevant to the topic may be added. Optionally, if multiple candidate questions and/or answers are available, the system also may select a question/answer group having one or more attributes that correspond to an attribute in the profile (such as a topic of interest) for the user to whom the digital lesson will be presented. The template may include a rule set for a lesson that will generate a set of prompts. When using the lesson, when a user successfully completes an exercise the lesson may advance to a next prompt.

The prompts may be displayed on a display device and/or output by an audio speaker. In some embodiments, the user may submit responses by keyboard, keypad, mouse or another input device. Alternatively or in addition, such as in embodiments that include pronunciation training, the system may enable the user to speak the response to the prompt, in which case a microphone will receive the response and the system will process the response using speech-to-text recognition to determine whether the response matches an expected response. In some embodiments, the speech-to-text recognition process may recognize whether the user correctly pronounced the response, and if the user did not do so, the system may output an audio presentation of the response with correct pronunciation.

Optionally, the system also may access database of user profiles to identify a profile for the user to whom the system presented the digital media asset, or a profile for the user to whom the system will present the lesson. The system may identify one or more attributes of the audience member. Such attributes may include, for example, geographic location, native language, preference categories (i.e., topics of interest), services to which the user subscribes, social connections, and other attributes. When lesson templates are stored from a data set, they may be associated with topics such as genre, named entity, geographic region, or other topic categories. When selecting a lesson template 208, if multiple templates are available the system may select one of those templates having content that matches or otherwise is complementary to one or more attributes of the user, such as a topics that match at least a threshold level of the user's interests. In addition, when generating the lesson 209, the system may identify key words in the content that match or are complementary to the user's interests, and it may use those key words to generate the prompts. The measurement of correspondence may be done using any suitable algorithm, such as selection of the template having metadata that matches the most of the audience member's attributes. Optionally, certain attributes may be assigned greater weights, and the system may calculate a weighted measure of correspondence.

When generating a lesson the system also may generate foils for key words. For example, the system may generate a correct definition and one or more foils that are false definitions, in which each foil is an incorrect answer that includes a word associated with a key vocabulary word that was extracted from the context. To generate foils, the system may select one or more words from the content source that are based on the part of speech of a word in the definition such as plural noun, adjective (superlative), verb (tense) or other criteria, and include those words in the foil definition.

The lesson also may include one or more digital media clips for each exercise 210. Each digital media clip may be a segment of the video and/or audio track of the digital media file from which the sentences and/or key words that are used in the exercise were extracted. The system may generate each clip by selecting a segment of the programming file having a timestamp that corresponds to the starting timestamp of the exercise's sentence or sentence sequence, and a duration that corresponds to the duration of the exercise's sentence or sentence sequence. Timestamps may “correspond” if they match, if they are within a maximum threshold range of each other, or if they are a predetermined function of each other (such as 1 second before or 1 second after the other).

The system will then save the lesson to a digital media server and/or serve the lesson to the audience member's media presentation device 211. Examples of this will be described below. The digital media server that serves the lesson may be the same one that served the digital video asset, or it may be a different server. Optionally, in some embodiments before serving the lesson to the user or saving the lesson to the system may present the lesson (or any question/answer set within the lesson) to an administrator computing device on a user interface that enables an administrator to view and edit the lesson (or lesson portion).

Optionally, when analyzing content of a digital media file, the system may determine whether the digital media file satisfies one or more screening criteria for objectionable content. The system may require that the digital media file and/or extracted sentence(s) satisfy the screening criteria before it will extract text and/or use the digital media file in generation of a lesson. If the digital media file or extracted sentences do not satisfy the screening criteria—for example, if a screening score generated based on an analysis of one or more screening parameters exceeds a threshold—the system may skip that digital media file and not use its content in lesson generation. Examples of such screening parameters may include parameters such as:
requiring that the digital media file originate from a source that is a known legitimate source (as stored in a library of sources), such as a known news reporting service or a known journalist;
requiring that the digital media file not originate from a source that is designated as blacklisted or otherwise suspect (as stored in a library of sources), such as a known “fake news” publisher;
requiring that the digital media file originate from a source that is of at least a threshold age;
requiring that the digital media file not contain any content that is considered to be obscene, profane or otherwise objectionable based on one or more filtering rules (such as filtering content containing one or more words that a library in the system tags as profane);
requiring that content of the digital media file be verified by one or more registered users or administrators.

The system may develop an overall screening score using any suitable algorithm or trained model. As a simple example, the system may assign a point score for each of the parameters listed above (and/or other parameters) that the digital media file fails to satisfy, sum the point scores to yield an overall screening score, and only use the digital media file for lesson generation if the overall screening score is less than a threshold number. Other methods may be used, such as machine learning methods disclosed in, for example, U.S. Patent Application Publication Number 2016/0350675 filed by Laks et al., and U.S. Patent Application Publication Number 2016/0328453 filed by Galuten, the disclosures of which are fully incorporated into this document by reference.

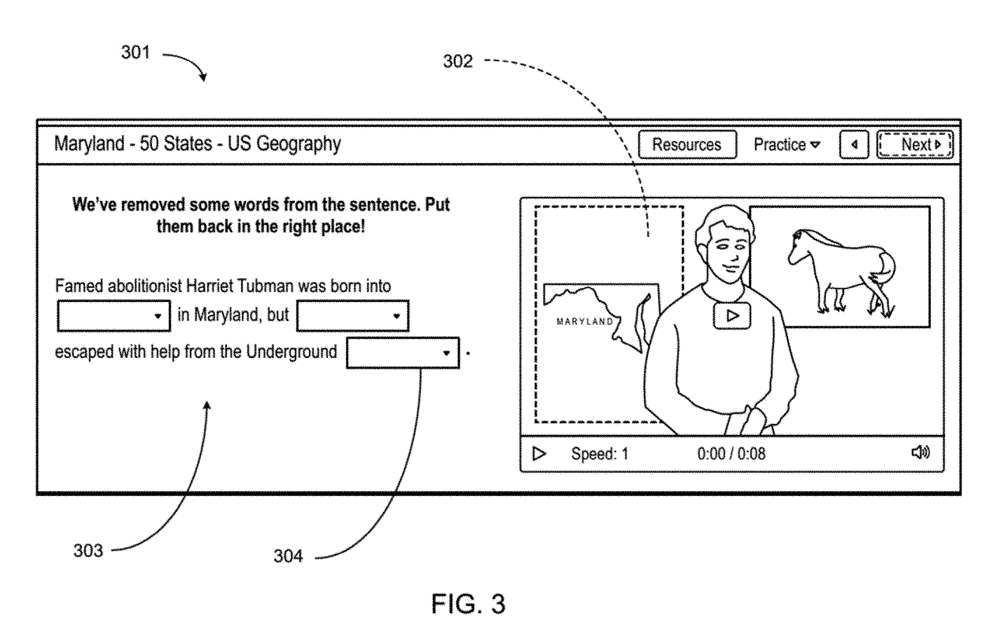

FIG. 3 illustrates an example in which an exercise 301 of a lesson is presented to a user via a display device of a media presentation device. This exercise 301 is a fill-in-the-blank exercise, and it includes a display screen segment that is a prompt-and-response sector 303 that displays a prompt from a video, with one or more key words removed in and replaced with one or more blanks 304 which the student is to fill in. The prompt-and-response sector 303 may receive user input to fill in the blanks as free-form text, by a selection of a candidate word from a drop-down menu (as shown), or by some other input means. Optionally, the exercise 301 may include a video presentation sector 302 in which a video that corresponds to the prompt is displayed in the prompt-and-response sector 303. The displayed video segment may be that created for the sentence using processes such as those described above in FIG. 2. The video presentation sector 302 may include a user actuator that receives commands from a user to start, pause, advance, go back, increase play speed, decrease play speed, show closed captions and/or hide closed captions in a video. When the user activates the actuator and causes the video to play, an audio output of the media presentation device may output audio comprising the sentence that is displayed in the prompt-and-response sector. In some embodiments, the prompt may not be displayed but instead may be only output via an audio output of the media presentation device. The system also may speak the prompt via an audio or video output section. The audio output of the prompt may include the complete prompt (including the key word), or the audio output may replace the key word with a blank, a sound, or another word (such as “blank”).

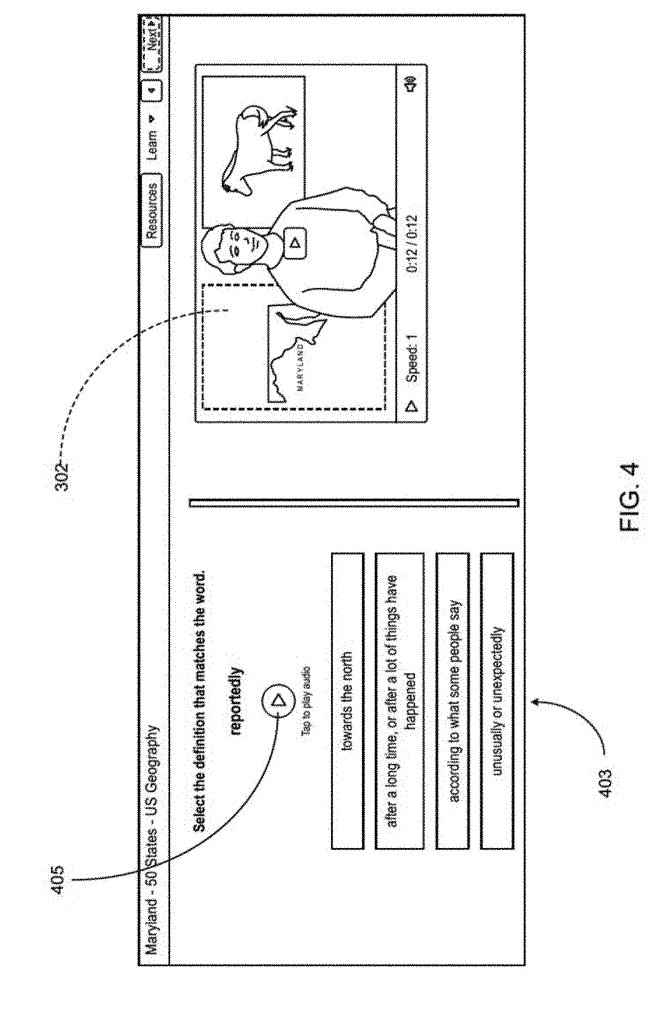

The prompt-and-response sector also may include other prompts, such as a sentence scramble exercise with a prompt to rearrange a list of words into a logical sentence (in which case the video segment displayed in the video presentation sector may be cued to the part of the video in which the sentence is spoken). Another possible prompt is a word scramble exercise with a prompt to rearrange a group of letters to make a word. The word will appear in a sentence spoken during the corresponding video segment. Another possible prompt is that of a definition exercise as shown in FIG. 4, in which the prompt displayed in the prompt-and-response sector is 403 to select a definition to match a particular word. The particular word may be displayed as shown, or it may be output by receiving a user selection of an audio output command 405. Other prompts are possible.

When presenting a lesson to a user, the system may analyze a user's response to each prompt to determine whether the response matches the correct response for the prompt. If the response is incorrect the prompt-and-response sector or another segment of the display, or an audio output, may output an indication of incorrectness such as an icon or word stating that the response is incorrect. On the other hand, if the response is correct the user's media presentation device may advance to the next exercise in the lesson and output a new prompt.

Referring back to FIG. 2, when serving a lesson, in some embodiments the system may prompt the user to speak a response, in which case a microphone will receive the spoken response and the system will record the response as a digital audio file 213. The system will process the response 215 using speech-to-text recognition to determine whether the response matches an expected response. A “match” may be an exact match, such as a direct match to a set of words in a dictionary or other word data set. In other situations, the system may determine that the response is one of several candidate responses, select the one that matches the expected response as a most probable response, and determine that a match exists because the most probable response is a match. In some embodiments, the speech-to-text recognition process 215 may be done by the system itself. In other embodiments, the system may transmit the digital audio file via a communication network to a third party service that will perform the speech-to-text recognition 215.

Optionally, when performing the speech to text recognition 215, the system may not only determine whether the spoken word matches an expected word, it may also determine whether the spoken word matches one, two, three, four or more alternate words. The system may select the alternate words as those, which are variations of the expected word such as different tenses or different singular/plural forms. The system also may select alternate words that are phonetically similar to the expected word. Alternatively, the system may select one or more alternate words at random, or using other selection criteria. Any of these options may help make the speech-to-text recognition process more accurate.

In some embodiments, the speech-to-text recognition process may recognize whether the user correctly pronounced the response. If the pronunciation was accurate 216, the system may output a positive reinforcement 217, such as a using text, graphics and/or sound to indicate that the user's pronunciation was correct. The user's media presentation device may then advance to the next exercise in the lesson and output a new prompt. If the spoken word does not match the expected word 218 the system may output an audio presentation of the response with correct pronunciation and again prompt 212 the user to speak the response.

Thus, the systems and methods described in this document may leverage and repurpose content into short, pedagogically structured, topical, useful and relevant lessons for the purpose of learning and practice of language and/or other skills on a global platform that integrates the content with a global community of users. In some embodiments, the system may include an ability to communicate between users that includes, but is not limited to, text chat, audio chat and video chat. In some situations, the lessons may include functionality for instruction through listening dictation, selection of key words for vocabulary study and key grammatical constructions (or very frequent collocations).

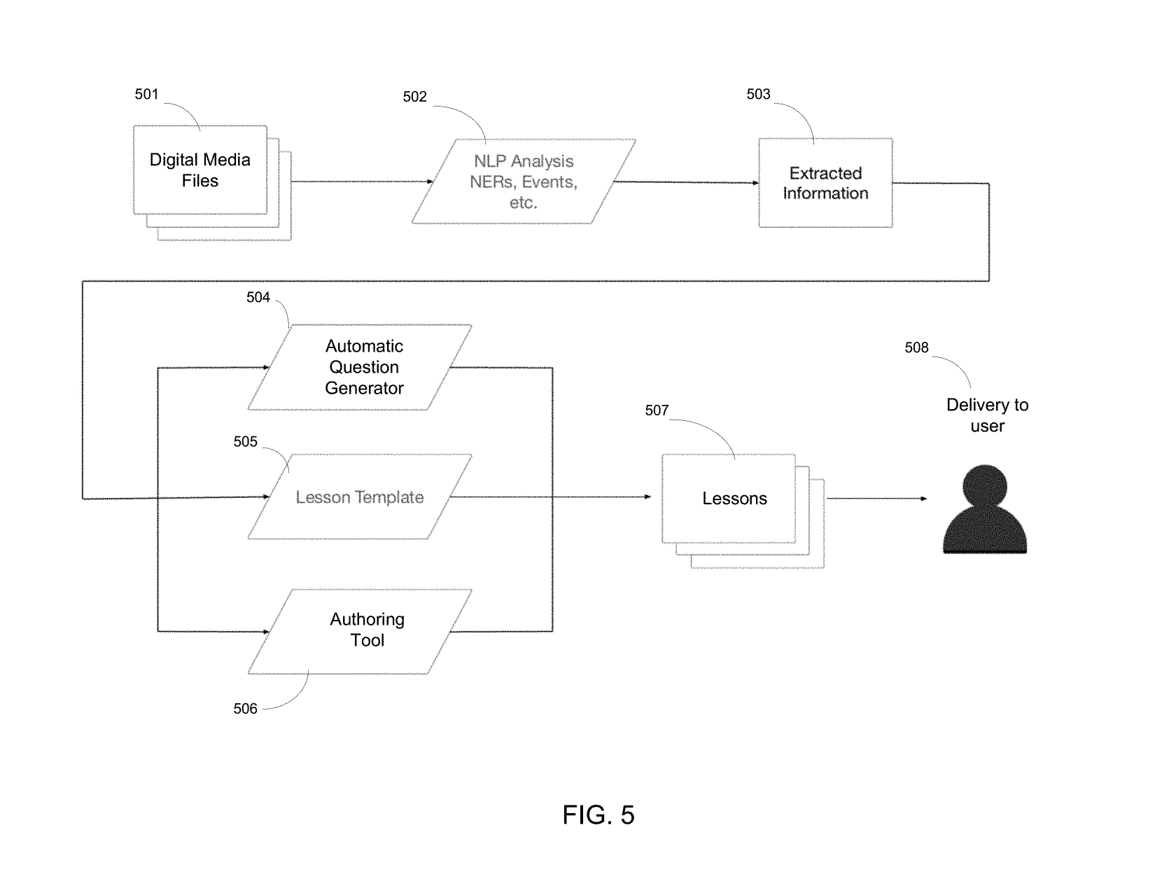

FIG. 5 illustrates an additional process flow. The system may select a digital media file from a data set of candidate digital media files 501. Each digital media file in the dataset may be associated with metadata that is descriptive of the programming file and its content, such as a category (sports, political news, music, etc.), a named entity (e.g., sports team, performer, newsworthy individual), and/or other descriptive material. To select a programming file, the system may access a profile for the user, identify one or more user interests in the profile, and select a programming file that matches or is complementary to one or more, or to a threshold number of, user interests in the profile. Some digital media files may have lessons generated and stored in a data storage facility. If so, then when retrieving a digital media file the system also may retrieve a corresponding lesson. If lessons are available the system also may use key words in the lesson to determine which lessons (and associated media files) to retrieve, by retrieving lessons having key words that match or are complementary to user interests. Content of a video (including accompanying text and/or audio that provides information about current news events, business, sports, travel, entertainment, or other consumable information) or other digital media file will include text in the form of words, sentences, paragraphs, and the like. If a lesson is not already available for the media file, the system may extract text from the media file and use the extracted text to generate a lesson. The extracted text may be integrated into a Natural Language Processing analysis methodology 502 that may include NER, recognition of events, and key word extraction. NER is a method of information extraction that works by locating and classifying elements in text into pre-defined categories (each, an “entity”) that is used to identify a person, place or thing. Examples of entities include the names of persons, organizations, locations, expressions of times, quantities, monetary values, percentages, etc. Events are activities or things that occurred or will occur, such as sporting events (e.g., basketball or football games, car or horse races, etc.), news events (e.g., elections, weather phenomena, corporate press releases, etc.), or cultural events (e.g., concerts, plays, etc.). Key word extraction is the identification of key words (which may include single words or groups of words—i.e., phrases) that the system identifies as “key” by any now or hereafter known identification process such as document classification and/or categorization and word frequency differential. The key word extraction process may look not only at single words that appear more frequently than others, but also at semantically related words, which the system may group together and consider to count toward the identification of a single key word.

The resulting output (extracted information 503) may be integrated into several components of a lesson generator, which may include components such as an automatic question generator 504, lesson template 505 (such as a rubric of questions and answers with blanks to be filled in with extracted information and/or semantically related information), and one or more authoring tools 506. Optionally, before using any material to generate a lesson, the lesson generator may ensure that the content analysis engine has first ensured that the material satisfies one or more screening criteria for objectionable content, using screening processes such as those described above.

The automatic question generator 504 creates prompts for use in lessons based on content of the digital media asset. (In this context, a question may be an actual question, or it may be a prompt such as a fill-in-the-blank or true/false sentence.) For example, after the system extracts the entities and events from content of the digital media file, it may: (1) rank events by how central they are to the content (e.g. those mentioned more than once, or those in the lead paragraph are more central and thus ranked higher); (2) cast the events into a standard template, via dependency parsing or a similar process, thus producing, for example: (a) Entity A did action B to entity C in location D, or (b) Entity A did action B which resulted in consequence E. The system may then (3) automatically create a fill-in-the-blank, multiple choice or other question based on the standard template. As an example, if the digital media asset content was a news story with the text: “Russia extended its bombing campaign to the town of Al Haddad near the Turkmen-held region in Syria in support of Assad's offensive,” then a multiple choice or fill-in-the-blank automatically generated question might be “Russia bombed ______ in Syria.” Possible answers to the question may include: (a) Assad; (b) Al Haddad; (c) Turkmen; and/or (d) ISIS, in which one of the answers is the correct named entity and the other answers are foils. In at least some embodiments, the method would not generate questions for the parts of the text that cannot be mapped automatically to a standard event template.

The lesson template 505 is a digital file containing default content, structural rules, and one or more variable data fields that is pedagogically structured and formatted for language learning. The template may include certain static content, such as words for vocabulary, grammar, phrases, cultural notes and other components of a lesson, along with variable data fields that may be populated with named entities, parts of speech, or sentence fragments extracted from a video.

The authoring tool 506 provides for a post-editing capability to refine the output based on quality control requirements for the lessons. The authoring tool 506 may include a processor and programming instructions that outputs the content of a lesson to an administrator via a user interface (e.g., a display) of a computing device, with input capabilities that enable the administrator to modify, delete, add to, or replace any of the lesson content. The modified lesson may then be saved to a data file for later presentation to an audience member 508.

Lesson production yields lessons 507 that are then either fully automated or partially seeded for final edits.

The system may then apply matching algorithms to customer/user profile data and route the lessons to a target individual user for language learning and language practice. Example algorithms include those described in United States Patent Application Publication Number 2014/0222806, titled “Matching Users of a Network Based on Profile Data”, filed by Carbonell et al. and published Aug. 7, 2014.

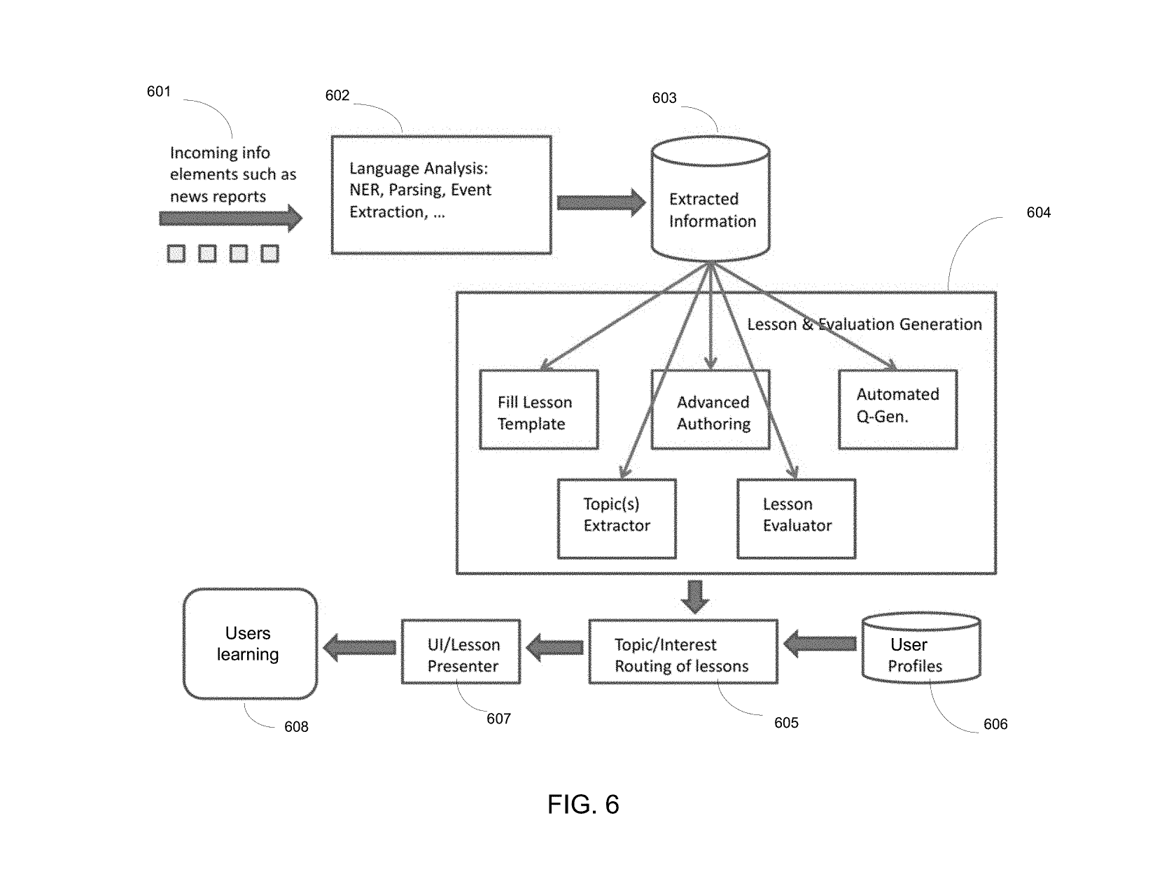

FIG. 6 illustrates additional details of an example of an automated lesson generation process, in this case focusing on the actions that the system may take to automatically generate a lesson. As with the previous figure, here the system may receive content 601, which may include textual, audio and/or video content. In some embodiments, such content may include news stories. In other embodiments, or in addition, the content may include narratives such as stories. In other embodiments, or in addition, the content may include specially produced educational materials. The content may include different subject matter in various embodiments.

The system in FIG. 6 uses automated text analysis techniques 602, such as classification/categorization to extract topics such as “sports” or “politics” or more refined topics such as “World Series” or “Democratic primary.” The methods used for automated topic categorization may be based on the presence of keywords and key phrases. In addition or alternatively, the methods may be machine learning methods trained from topic-labeled texts, including decision trees, support-vector machines, neural networks, logistic regression, or any other supervised or unsupervised machine learning method. Another part of the text analysis may include automatically identifying named entities in the text, such as people, organizations and places. These techniques may be based on finite state transducers, hidden Markov models, conditional random fields, deep neural networks with LSTM methods or such other techniques as a person of skill in the art will understand, such as those discussed above or other similar processes and algorithms from machine learning. Another part of the text analysis may include automatically identifying and extracting events from the text such as who-did-what-to-whom (for example, voters electing a president, or company X selling product Y to customers Z). These methods may include, for example, those used for identifying and extracting named entities, and also may include natural language parsing methods, such as phrase-structure parsers, dependency parsers and semantic parsers.

In 604, the system addresses creation of lessons and evaluations based on the extracted information. These lessons can include highlighting/repeating/rephrasing extracted content. The lessons can also include self-study guides based on the content. The lessons can also include automatically generated questions based on the extracted information (such as “who was elected president”, or “who won the presidential election”), presented in free form, in multiple-choice selections, as a sentence scramble, as a fill-in-the-blank prompt, or in any other format understandable to a student. Lessons are guided by lesson templates that specify the kind of information, the quantity, the format, and/or the sequencing and the presentation mode, depending on the input material and the level of difficulty. In some embodiments, a human teacher or tutor interacts with the extracted information 603, and uses advanced authoring tools to create the lesson. In other embodiments, the lesson creation, may be automated, using the same resources available to the human teacher, plus algorithms for selecting and sequencing content to fill in the lesson templates and formulate questions for the students. These algorithms are based on programmed steps and machine learning-by-observation methods that replicate the observed processes of the human teachers. Such algorithms may be based on graphical models, deep neural nets, recurrent neural network algorithms or other machine learning methods.

Finally, lessons are coupled with extracted topics and matched with the profiles of users 606 (students) so that the appropriate lessons may be routed to the appropriate users 605. Each lesson is associated with metadata indicating one or more topics (e.g., genre, category, named entity, etc.), and to select a user to whom the lesson will be delivered, the system may access user profiles and identify a user having at least a threshold number of interests that match or are complementary to the lesson topic(s). Alternatively, the system may access a data set of lessons and select a lesson that has a topic or topics that match or are complementary to interest(s) of a particular user. As previously noted, a match may be an exact match, a semantically similar match, or otherwise complementary (e.g., identified as such in a knowledge set). The matching process may be done by a similarity metric, such as dot-product, cosine similarity, inverse Euclidean distance, or any other well-defined matching methods of interests vs. topics, such as the methods taught in United States Patent Application Publication Number 2014/0222806, titled “Matching Users of a Network Based on Profile Data”, filed by Carbonell et al. and published Aug. 7, 2014. Each lesson may then be presented to the user 607 via a user interface (e.g., display device) of the user's media presentation device so that the user is assisted in learning 608 a skill that is covered by the lesson.

Optionally, the system may include additional features when generating a lesson. For example, the system may present the student user with a set of categories, such as sports, world news, or the arts, and allow the user to select a category. The system may then search its content server or other data set to identify one or more digital media files that are tagged with the selected category, or with a category that is complementary to the selected category. The system may present indicia of each retrieved digital media file to the user so that the user can select any of the programming files for viewing and/or lesson generation. The system will then use the selected digital media files as content sources for lesson generation using the processes described above.

Example lessons that the system may generate include:

(1) Vocabulary lessons, in which words extracted from the text (or variants of the word, such as a different tense of the word) are presented to a user along with a correct definition and one or more distractor definitions (also referred to as “foil definitions”) so that the user may select the correct definition in response to the prompt. The distractor definitions may optionally contain content that is relevant to or extracted from the text.

(2) Fill-in-the-blank prompts, in which the system presents the user with a paragraph, sentence or sentence fragment. Words extracted from the text (or variants of the word, such as a different tense of the word) must be used to fill in the blanks.

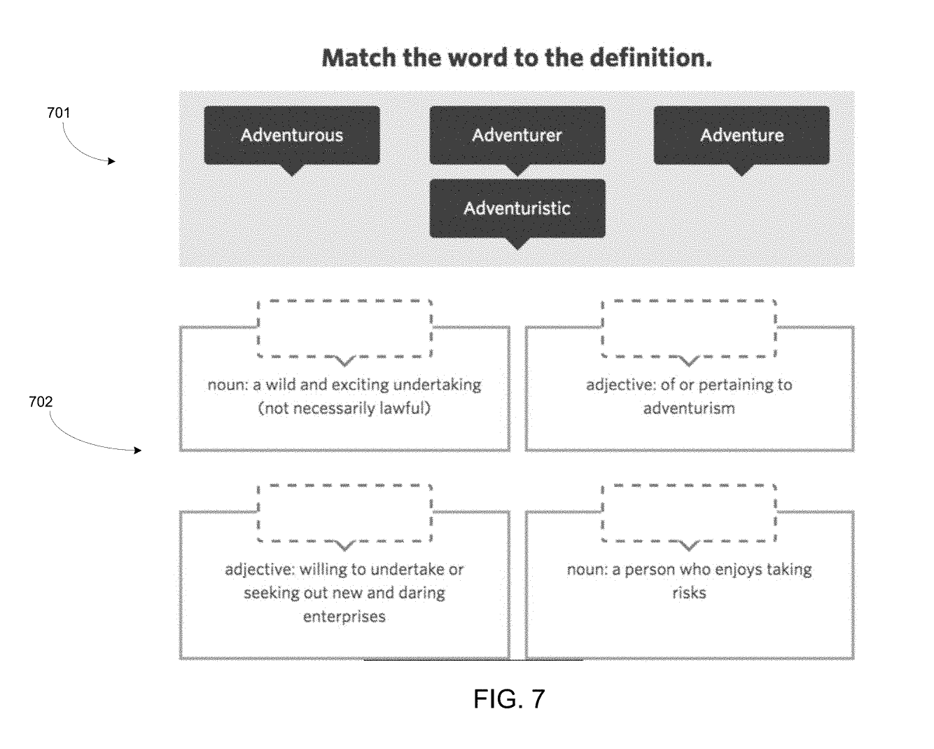

(3) Word family questions, in which the system takes one or more words from the digital media file and generates other forms of the word (such as tenses). The system may then identify a definition for each form of the word (such as by retrieving the definition from a data store) and optionally one or more distractor definitions and ask the user to match each variant of the word with its correct definition. FIG. 7 illustrates an example screenshot of such an exercise, with a sector 701 displaying a set of words and a second sector 702 displaying a set of definitions. A user may match words with definitions using a drag-and-drop input or other matching action.

(4) Opposites, in which the system outputs a word from the text and prompts the user to enter or select a word that is an opposite of the presented word. Alternatively, the system may require the user to enter a word from the content that is the opposite of the presented word.

(5) Sentence scrambles, in which the system presents a set of words that the user must rearrange into a logical sentence. Optionally, some or all of the words may be extracted from the content.

Optionally, when presenting a lesson, the system may cause the media presentation device to interleave the prompts with the content of the digital media file. For example, referring back to FIG. 3, the system may cause the media presentation device to play a digital media file in a presentation sector 302 of a display, and it may output prompts in a call-and-response sector 303 of the display. Each prompt may be associated with a timestamp so that as the media file plays, at various times during presentation of the media file the outputted prompts will have timestamps that synchronize to the a timestamp of the portion of the media file that is being output. Optionally, when a prompt is presented, the system may cause the presentation sector 302 to pause the media file until the system receives a response to the prompt. Optionally, the system may include a timer that starts when a prompt is presented, and the system may move on to a next prompt, or output an alternate prompt, if the user does not respond to a prompt before a threshold period of time elapses. Although this example shows prompts presented with a digital media file that is a video, the process also may be used with output audio files and audio prompts, or text (in which prompts are synchronized to appear before or after sentences having keywords or topics that correspond to a key word of the prompt).

In some embodiments, the system may update the user's profile with information that the system can use to assess user interests in the future. For example, if a user completes all (or at least a threshold number of) prompts in a lesson that is associated with a particular topic, the system may update the user's profile to indicate that the topic is of interest to the user. On the other hand, if a user does not complete at least a threshold number of prompts in a lesson, the system may update the user's profile to indicate that the lesson's topic was not of interest to the user.

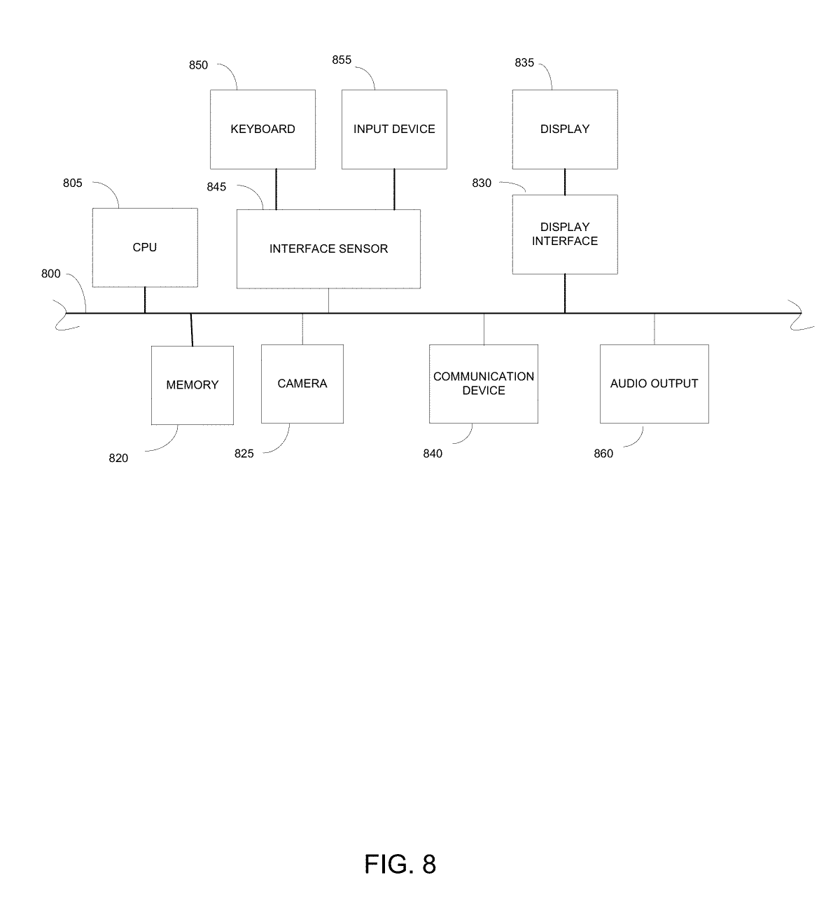

FIG. 8 depicts an example of hardware components that may be included in any of the electronic components of the system, such as a media presentation device or a remote server. An electrical bus 800 serves as an information highway interconnecting the other illustrated components of the hardware. Processor 805 is a central processing device of the system, i.e., a computer hardware processor configured to perform calculations and logic operations required to execute programming instructions. As used in this document and in the claims, the terms “processor” and “processing device” are intended to include both single-processing device embodiments and embodiments in which multiple processing devices together or collectively perform a process. Similarly, a server may include a single processor-containing device or a collection of multiple processor-containing devices that together perform a process. The processing device may be a physical processing device, a virtual device contained within another processing device (such as a virtual machine), or a container included within a processing device.

Read only memory (ROM), random access memory (RAM), flash memory, hard drives and other devices capable of storing electronic data constitute examples of memory devices 820 that may serve as a data storage facility. Except where specifically stated otherwise, in this document the terms “memory,” “memory device,” “data store,” “data storage facility,” computer-readable medium,” “computer-readable memory device” and the like are intended to include single device embodiments, embodiments in which multiple memory devices together or collectively store a set of data or instructions, as well as individual sectors within such devices.

An optional display interface 830 may permit information from the bus 800 to be displayed on a display device 835 in visual, graphic or alphanumeric format. An audio interface and audio output 860 (such as a speaker) also may be provided. Communication with external devices may occur using various communication devices 840 such as a transmitter and/or receiver, antenna, a radio frequency identification (RFID) tag and/or short-range or near-field communication circuitry. A communication device 840 may be attached to a communications network, such as the Internet, a local area network or a cellular telephone data network.

The hardware may also include a user interface sensor 845 that allows for receipt of data from input devices such as a keyboard 850, a mouse, a joystick, a touch screen, a remote control, a pointing device, a video input device and/or an audio input device (i.e., microphone) 855. Data also maybe received from a video capturing device 825 (i.e., camera) or device that receives positional data from an external global positioning system (GPS) network.

While the embodiments described above use the example of a digital video file, one of skill in the art will recognize that the methods described above may be used with an audio-only file that includes an accompanying transcript, such as an audio podcast, a streaming radio service, and the like. Digital audio files may be distributed by a digital media service, such as a video delivery service, an online streaming service, and the like.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A system for processing digital media files and automatically generating digital lesson content based on content of the digital media files, the system comprising:
a processor;
a digital media server comprising a data storage facility that contains a set of digital media files; and
a memory device containing programming instructions that are configured to cause the processor to:
select, from the set of digital media files, a digital media file,
analyze a set of text corresponding to words spoken in the selected digital media file and extract a text segment from the set of text,
generate a digital media clip that corresponds to the text segment, wherein the digital media clip has a start time in the selected digital media file that corresponds to the start time of the text segment,
extract one or more key words that appear in the text segment, and
generate a lesson comprising an exercise that includes:
a prompt that uses the one or more key words extracted from the text segment, and
the digital media clip, and
save the lesson to a data storage facility as a digital media file.

2. The system of claim 1, further comprising programming instructions that are configured to cause a media presentation device to output the lesson by:
displaying the prompt in a prompt-and-response sector of a display of the media presentation device wherein a user may enter a response to the prompt; and
displaying the digital media clip in a video presentation sector of the display with an actuator via which the user may cause the media presentation device to play the digital media clip and output audio comprising the text segment.

3. The system of claim 1, further comprising programming instructions that are configured to cause a media presentation device to output the lesson by:
outputting the prompt;
receiving a spoken response to the prompt via a microphone;
analyzing the spoken response to determine whether the spoken response matches the key word;
if the spoken response matches the key word, outputting a positive reinforcement; and
if the spoken response does not match the key word, outputting the key word via an audio speaker and continuing to output the prompt and receive additional spoken responses until an additional spoken response that matches the key word is received.

4. The system of claim 1, wherein the instructions to extract the one or more key words comprise instructions to identify one or more key words that appear in the selected digital media file with a frequency that exceeds a threshold.

5. The system of claim 1, wherein the set of text comprises a transcript that includes a plurality of text segments and a plurality of timestamps, and each timestamp corresponds to one of the text segments.

6. The system of claim 1, wherein the one or more key words are semantically related.

7. The system of claim 1, further comprising programming instructions configured to cause the processor to, before extracting the one or more key words from the text segment, analyze the content of the text segment to determine that the content satisfies one or more screening criteria for objectionable content.

8. The system of claim 1, wherein:
the one or more key words comprise a named entity and an event extracted from the text segment; and
the programming instructions for generating the lesson comprise programming instructions configured to cause the processor to:
rank the event by how central the event is to the content of the text segment, and
use dependency parsing to cast the named entity and the event into a template.

9. The system of claim 1, wherein:
the exercise comprises one or more foils for the one or more key words extracted from the sentence; and
the programming instructions for generating the lesson also comprise additional programming instructions configured to cause the processor to select the one or more foils from one or more words in the text segment.

10. The system of claim 1, wherein:
the exercise comprises a fill-in-the-blank exercise, and the prompt is a blank in the text segment wherein a user may insert one of the key words in the blank;
the exercise comprises a sentence scramble exercise, and the prompt is a field in which a user may arrange key words from the text segment in order;
the exercise comprises a word scramble exercise, and the prompt is a field in which a user may arrange a set of letters into one of the key words; or
the exercise comprises a definition exercise, and the prompt is a field in which a user may select a definition for one of the key words.

11. The system of claim 1, further comprising additional programming instructions that are configured to cause the processor to:
identify a topic for the lesson;
access a plurality of user profiles, each of which includes one or more interests for a user that is associated with the user profile;
identify a user having at least a threshold level of interests that match or are complementary to the topic; and
cause the lesson to be delivered to the identified user.

12. The system of claim 1, further comprising additional programming instructions that are configured to cause the processor to:
receive a user identifier for a user;
access a data set of user profiles and use the user identifier to identify a user profile in the data set that corresponds to the user;
identify one or more topics of interest that are in the identified user profile;
select, from a data set of lessons that includes the generated lesson, a lesson having at least a threshold level of topics that match or are complementary to one or more topics of interest in the identified user profile; and
cause the selected lesson to be presented to the user via a media presentation device.

13. A system for processing digital media files and automatically generating and presenting digital lesson content based on content of the digital media files, the system comprising:
a lesson generation engine comprising a computer-readable medium with programming instructions that are configured to cause a processing device to:
analyze a set of text in a digital media file and identify a text segment in the text,
identify a key word in the text segment, and
generate a lesson that includes a prompt in which the key word is replaced with a blank;
a memory device with programming instructions that are configured to cause a media presentation device to:
output the prompt to a user, and
receive, via a microphone, a spoken response to the prompt; and
a memory device with programming instructions that are configured to cause a processing device to:
analyze the spoken response to determine whether the spoken response matches the key word,
if the spoken response matches the key word, cause the media presentation device to output a positive reinforcement, and
if the spoken response does not match the key word, cause the media presentation device to output the key word via an audio speaker and continue to output the prompt and receive additional spoken responses until an additional spoken response matches the key word.

14. The system of claim 13, wherein the instructions to analyze the spoken response to determine whether the spoken response matches the key word comprise instructions to compare the spoken response to audio characteristics of the key word and one or more variations of the key words.

15. The system of claim 14, wherein the one or more variations of the key word comprise one or more alternate tenses of the key word or one or more alternate singular/plural forms of the key word.

16. The system of claim 13, wherein the instructions to analyze the spoken response to determine whether the spoken response matches the key word comprise instructions to transmit the spoken response to a speech-to-text recognition service.

17. The system of claim 13, wherein the instructions to output the prompt to the user comprise instructions to display text of the prompt with the blank instead of the key word, and also to output the prompt in a spoken audio form that includes the key word.

18. The system of claim 13, wherein the lesson generation engine also comprises programming instructions that are configured to cause the processing device to:
identify a topic for the lesson;
access a plurality of user profiles, each of which includes one or more interests for a user that is associated with the user profile;
identify a user having at least a threshold level of interests that match or are complementary to the topic; and
cause the lesson to be delivered to the identified user;
wherein the media presentation device is a media presentation device of the identified user.

19. The system of claim 13, further comprising additional programming instructions that are configured to cause the processor to:
receive a user identifier for the user;
access a data set of user profiles and use the user identifier to identify a user profile in the data set that correspond to the user;
identify one or more topics of interest that are in the identified user profile;
select, from a data set of lessons that includes the generated lesson, a lesson having at least a threshold level of topics that match or are complementary to one or more topics of interest in the identified user profile; and
cause the selected lesson to be presented to the user via the media presentation device so that the media presentation device outputs the prompt

20. A method of processing digital media files and automatically generating digital lesson content based on content of the digital media files, the method comprising:
by a lesson generation engine:
analyzing a set of text in a digital media file and identify a text segment in the text,
identifying a key word in the text segment, and
generating a lesson that includes a prompt in which the key word is replaced with a blank; and
by a processor:
causing a media presentation device to output the prompt to a user,
receiving a spoken response to the prompt,
analyzing the spoken response to determine whether the spoken response matches the key word,
if the spoken response matches the key word, causing the media presentation device to output a positive reinforcement, and
if the spoken response does not match the key word, causing the media presentation device to output the key word via an audio speaker and continue to output the prompt and receive additional spoken responses until an additional spoken response matches the key word.
